(19) United States
(12) Patent Application Publication
(10) Pub. No.: US 2012/0302214 A1
(43) Pub. Date: Nov. 29, 2012

(54) COMMUNICATION DEVICE, STORAGE MEDIUM AND METHOD FOR AVOIDING UNFINISHED PHONE CALLS

(75) Inventor: JUN LI, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/300,616

(22) Filed: Nov. 20, 2011

(30) Foreign Application Priority Data
May 24, 2011 (CN) 201110137260.X

(51) Int. Cl. H04W 4/12; H04W 4/00

(52) U.S. Cl. 455/412.2; 455/414.1

(57) ABSTRACT

In a method for avoiding interrupting a phone call of a communication device, a prompt mode of the communication device is set for reminding that the phone call is not complete. The method detects whether voice signals from a second communication device is still being received when the communication device generates the phone call with the second communication device. If the communication device is communicating with the second communication device and the receiver has received the voice signal, the method prompts a user that the phone call is not complete according to the prompt mode.

### BACKGROUND

1. Technical Field

Embodiments of the present disclosure relate to communication systems and methods, and more particularly to a communication device, storage medium and method for avoiding unfinished phone calls.

2. Description of Related Art

Sometimes, when a caller uses a communication device (e.g., a cell phone) with another communication device (e.g., a second communication device) of a callee, the caller or the callee may wrongly consider the phone call being complete, and ends the phone call. This can cause problems when the caller or the callee still wants to communicate with callee or the caller who wrongly considers the phone call being complete. Therefore, the phone call may be interrupted unexpected and cannot be complete perfectly.

### BRIEF DESCRIPTION OF THE DRAWINGS

FIG. 1 is a block diagram of one embodiment of a communication device including a protection system.

FIG. 2 is a flowchart of a first embodiment of a method for avoiding unfinished phone calls in the communication device of FIG. 1.

FIG. 3 is a flowchart of a second embodiment of a method for avoiding unfinished phone calls in the communication device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

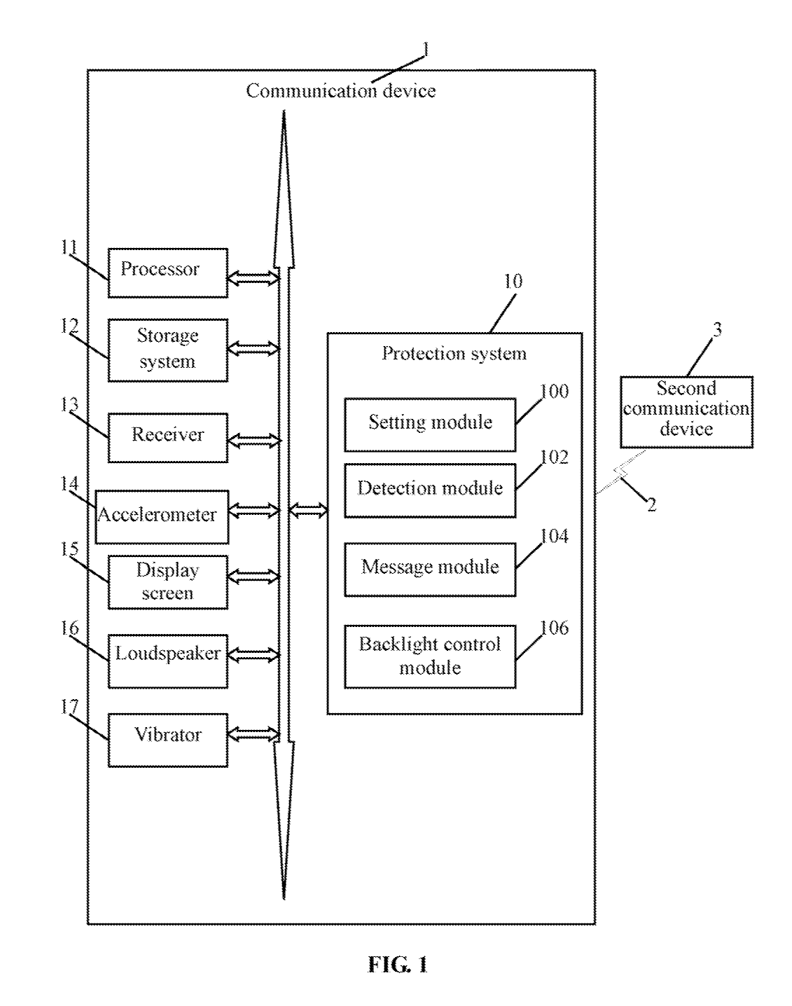

FIG. 1 is a block diagram of one embodiment of a communication device 1 including a protection system 10 used to avoid unfinished phone calls. The communication device 1 may communicate with a second communication device 3 via a phone call, through a network 2, such as a Global System for Mobile Communications (GSM) network. In response to the protection system 10 detecting that the communication device 1 continues to receive voice signals from the second communication device 3, a user of the communication device 1 is prompted that the phone call is not complete (e.g., is unfinished), to avoid an unexpected hang up between the communication device 1 and the second communication device 3. In one embodiment, the communication device 1 and the second communication device 3 may be mobile phones.

The communication device 1 further includes a receiver 13. When the communication device 1 communicates with the second communication device 3, the receiver 13 receives the voice signals from the second communication device 3 through the network 2. In one embodiment, the voice signals may be in digital or analog form. The communication device 1 may further include a converter or other device (not shown in FIG. 1), to receive and transmit the voice signals of the communication device 1 to the second communication device 3.

The communication device 1 further includes at least one processor 11, a storage system 12, a display screen 15, a loudspeaker 16 and a vibrator 17. The at least one processor 11 executes one or more computerized codes and other applications of the communication device 1, to provide functions of the protection system 10. The storage system 12 stores data of the communication device 1, such as a phone book and calling records, for example. The storage system 12 may be a memory of the communication device 1, or an external storage card, such as a smart media card, or a secure digital card. The display screen 15 displays visual data of the communication device 1, such as, messages, images of the communication device 1. The loudspeaker 16 may play various audio types, such as voice, music and audio files, for example. The vibrator 17 may cause the communication device 1 to vibrate according to a preset command.

In the embodiment, the protection system 10 may include a setting module 100, a detection module 102, a message module 104, and a backlight control module 106. The modules 100, 102, 104, and 106 comprise computerized codes in the form of one or more programs that are stored in the storage system 12. The computerized code includes instructions that are executed by the at least one processor 11 to provide functions for the modules. Details of these operations are as follows.

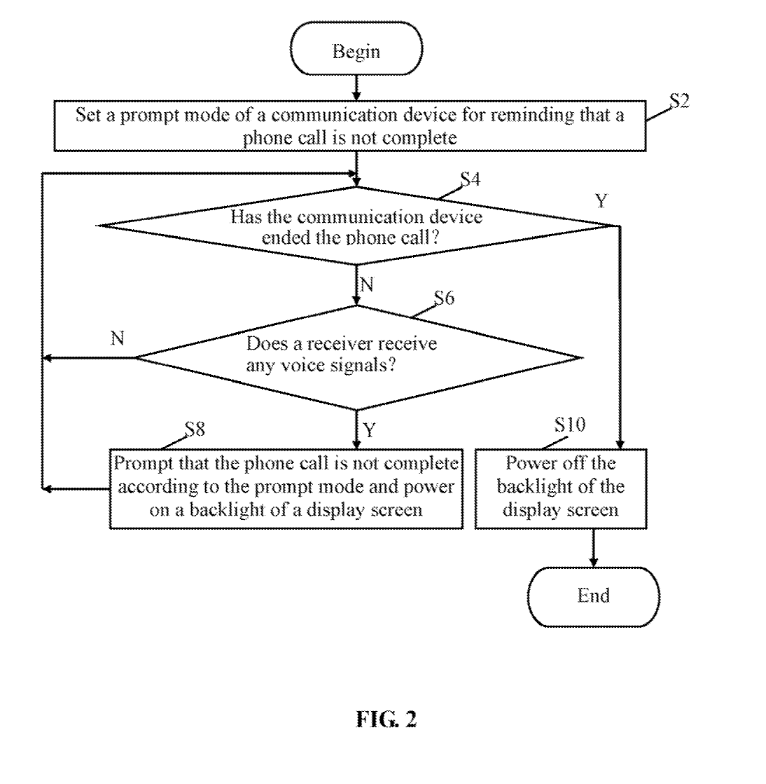

FIG. 2 is a flowchart of a first embodiment of a method for avoiding unfinished phone calls of the communication device 1 of FIG. 1. Depending on the embodiment, additional blocks may be added, others deleted, and the ordering of the blocks may be changed.

In block S2, the setting module 100 sets a prompt mode of the communication device 1. In the prompt mode, the user can configure system settings that allow for reminder that the phone call when the communication device 1 and the second communication device 3 is not complete. Configuration of the system settings include display of messages, output of audio data, or vibration of the communication device. In one embodiment, the prompt mode may include displaying a predetermined text message, outputting a predetermined voice message, and/or vibrating the communication device 1 according to user preference. For example, the text message or the voice message may be “Attention, the call is not complete”.

When the communication device 1 generates the phone call with the second communication device 3, in block S4, the detection module 102 determines whether the communication device 1 has ended the phone call. If the communication device 1 has not ended the phone call, block S6 is implemented. If the communication device 1 has ended the phone call, block S10 is implemented.

In block S6, the detection module 102 detects whether the receiver 13 is receiving voice signals from the second communication device 3. If the detection module 102 detects that the receiver 13 is receiving the voice signals, block S8 is implemented. Otherwise, if the detection module 102 detects that the receiver 13 is not receiving any voice signals, block S4 is repeated.

In block S8, the message module 104 prompts the user of the communication device 1 that the phone call is not complete according to the prompt mode. The message module 104 may prompt the user of the communication device 1 by displaying the predetermined text message on the display screen 15, outputting the predetermined voice message through the loudspeaker 16, and/or vibrating the communication device 1 through the vibrator 17. In other embodiments, if the receiver 13 has been receiving the voice signals, in block S8, the backlight control module 106 may power on a backlight of the display screen 15, or maintain the backlight of the display screen 15 still to be powered on.

In block S10, the backlight control module 106 powers off the backlight of the display screen 15, or maintains the backlight to be powered off.

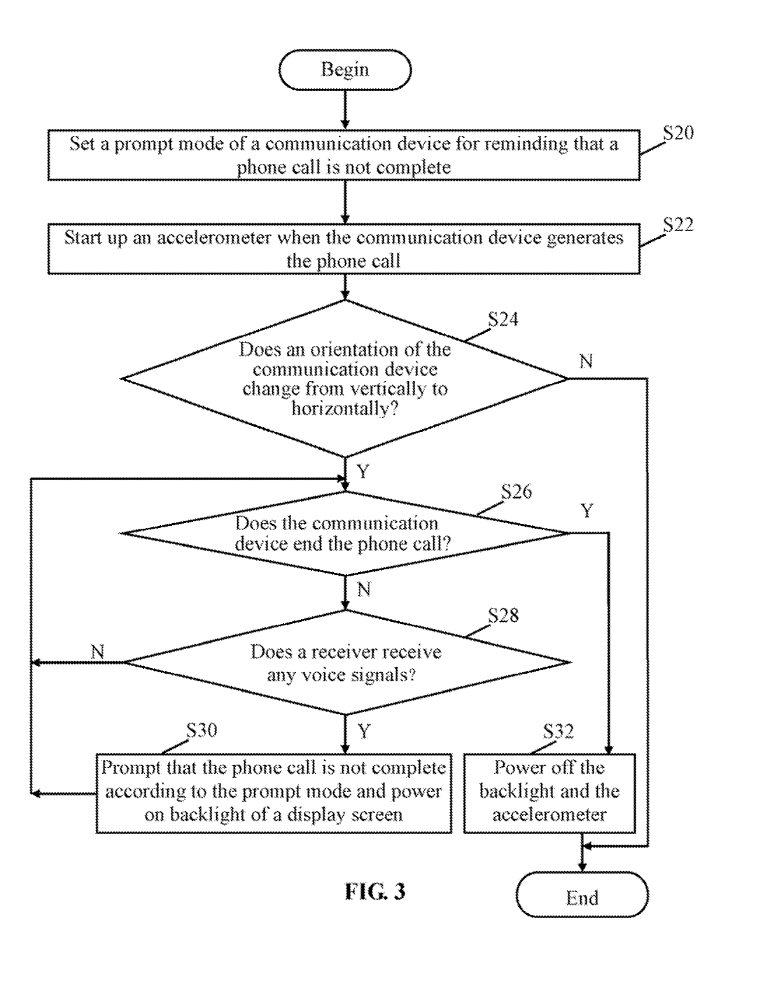

FIG. 3 is a flowchart of a second embodiment of a method for avoiding unfinished phone calls of the communication device 1 of FIG. 1. Depending on the embodiment, additional blocks may be added, others deleted, and the ordering of the blocks may be changed.

In the second embodiment, the communication device 1 may further include an accelerometer 14. The accelerometer 14 may determine whether the communication device 1 is in a vertical or in a horizontal orientation. The orientation of the communication device 1 can be determined according to a predetermined angle range. If angle between the communication device 1 and a horizontal plane is in a range of [75 degrees, 105 degrees], the communication device 1 is determined to be in the vertical orientation. The horizontal plane represents a plane of the display screen 15 when the communication device is placed horizontally. If the angle between the communication device 1 and the horizontal plane is in the range of [0 degrees, 5 degrees], the communication device 1 is determined to be in the horizontal orientation. Details of these operations are as follows.

In block S20, the setting module 100 sets the prompt mode of the communication device 1 for reminding the user that the phone call is not complete.

When the communication device 1 generates the phone call with the second communication device 3, in block S22, the detection module 102 enables the accelerometer 14 of the communication device 1 to determine the orientation of the communication device 1.

In block S24, the detection module 102 determines whether the communication device 1 changes from the vertical orientation to the horizontal orientation using the accelerometer 14. If the communication device 1 does not change from the vertical orientation to the horizontal orientation, the procedure ends. If the communication device changes from the vertical orientation to the horizontal orientation, that is deemed to represent the user intending to put down the communication device 1 and end the call.

If the orientation of the communication device 1 changes from the vertical to the horizontal, in block S26, the detection module 102 determines whether the communication device 1 has ended the phone call. If the communication device 1 has ended the phone call, block S32 is implemented.

If the communication device 1 has not ended the phone call, in block S28, the detection module 102 detects whether the receiver 13 is receiving voice signals from the second communication device 3. If the detection module 102 detects that the receiver 13 is not receiving any voice signal, block S26 is repeated.

If the detection module 102 detects that the receiver 13 is receiving the voice signal, in block S30, the message module 104 prompts for the user of the communication device 1 that the phone call is not complete according to the prompt mode. The backlight control module 106 then powers on a backlight of the display screen 15, or maintains the backlight of the display screen 15 still to be powered on, and block S26 is repeated.

In block S32, the backlight control module 106 powers off the backlight of the display screen 15, or maintains the backlight to be powered off, and disables the accelerometer 14.

All of the processes described above may be embodied in, and fully automated via, functional code modules executed by one or more general purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A communication device, comprising:
a display screen
a storage system;
at least one processor; and
one or more programs that are stored in the storage system and executed by the at least one processor, the one or more programs comprising:
a setting module operable to set a prompt mode of the communication device, the prompt mode according to user configurable settings that a phone call of the communication device to a second communication device is not complete;
a detection module operable to detect whether a receiver of the communication device is receiving voice signals from the second communication device, upon the condition that the communication device generates the phone call with the second communication device;
a message module operable to prompt a user of the communication device that the phone call is not complete according to the prompt mode, upon the condition that the receiver is receiving the voice signals from the second communication device.

2. The communication device as claimed in claim 1, wherein the detection module further operable to determine whether the communication device changes from a vertical orientation to a horizontal orientation through an accelerometer of the communication device, upon the condition that the communication device generates the phone call with the second communication device and before the communication device detecting whether the receiver is receiving the voice signals.

3. The communication device as claimed in claim 2, wherein the one or more programs further comprises:
a backlight control module operable to power on a backlight of the display screen and maintain the backlight of the display screen to be powered on, upon the condition that the receiver is receiving the voice signals from the second communication device.

4. The communication device as claimed in claim 3, wherein the backlight control module further operable to power off the backlight of the display screen and maintain the backlight to be powered off, upon the condition that the communication device ends the phone call with the second communication device.

5. The communication device as claimed in claim 1, wherein the prompt mode comprises a mode of displaying a predetermined text message, a mode of outputting a predetermined voice message, and/or a mode of vibrating the communication device.

6. The communication device as claimed in claim 5, wherein the message module displays the predetermined text message through the display screen, outputs the predetermined voice message through a loudspeaker of the communication device, and vibrates the communication device through a vibrator of the communication device.

7. A computer-implemented method for avoiding interrupting a phone call of a communication device, the method comprising:
setting a prompt mode of the communication device, the prompt mode according to user configurable settings that a phone call of the communication device to a second communication device is not complete;
detecting whether a receiver of the communication device is receiving voice signals from a second communication device, upon the condition that the communication device generates the phone call with the second communication device;
prompting for a user of the communication device that the phone call is not complete according to the prompt mode, upon the condition that the receiver is receiving the voice signals from the second communication device.

8. The method as claimed in claim 7, further comprising:
determining whether the communication device changes from a vertical orientation to a horizontal orientation through an accelerometer of the communication device, upon the condition that the communication device generates the phone call with the second communication device and before the communication device detecting whether the receiver has is receiving the voice signals.

9. The method as claimed in claim 8, further comprising:
powering on a backlight of a display screen of the communication device and maintaining the backlight of the display screen to be powered on, upon the condition that the receiver is receiving the voice signals from the second communication device.

10. The method as claimed in claim 9, further comprising:
powering off the backlight of the display screen or maintaining the backlight to be powered off, upon the condition that the communication device ends the phone call with the second communication device.

11. The method as claimed in claim 7, wherein the prompt mode comprises a mode of displaying a predetermined text message, a mode of outputting a predetermined voice message, and/or a mode of vibrating the communication device.

12. The method as claimed in claim 11, wherein the prompt mode displays the predetermined text message through the display screen, outputs the predetermined voice message through a loudspeaker of the communication device, and vibrates the communication device through a vibrator of the communication device.

13. A non-transitory storage medium storing a set of instructions, the set of instructions capable of being executed by at least one processor of a communication device, causes the at least one processor to perform a method for avoiding interrupting a phone call of the communication device, the method comprising:
setting a prompt mode of the communication device, the prompt mode according to user configurable settings that a phone call of the communication device to a second communication device is not complete;
detecting whether a receiver of the communication device is receiving voice signals from a second communication device, upon the condition that the communication device generates the phone call with the second communication device;
prompting for a user of the communication device that the phone call is not complete according to the prompt mode, upon the condition that the receiver is receiving the voice signals from the second communication device.

14. The storage medium as claimed in claim 13, wherein the method further comprises:
determining whether the communication device changes from a vertical orientation to a horizontal orientation through an accelerometer of the communication device, upon the condition that the communication device generates the phone call with the second communication device and before the communication device detecting whether the receiver is receiving voice signals

15. The storage medium as claimed in claim 14, wherein the method further comprises:
powering on a backlight of a display screen of the communication device and maintaining the backlight of the display screen to be powered on, upon the condition that the receiver is receiving the voice signals from the second communication device.

16. The storage medium as claimed in claim 15, wherein the method further comprises:
powering off the backlight of the display screen or maintaining the backlight to be powered off, upon the condition that the communication device ends the phone call with the communication device.

17. The storage medium as claimed in claim 13, wherein the prompt mode comprises a mode of displaying a predetermined text message, a mode of outputting a predetermined voice message, and/or a mode of vibrating the communication device.

18. The storage medium as claimed in claim 17, wherein the prompt mode displays the predetermined text message through the display screen, outputs the predetermined voice message through a loudspeaker of the communication device, and vibrates the communication device through a vibrator of the communication device.
